(19) United States
(12) Patent Application Publication
(10) Pub. No.: US 2015/0216751 A1
(43) Pub. Date: Aug. 6, 2015

(54) PATIENT TRANSPORT DEVICE

(71) Applicant: HUNTLEIGH TECHNOLOGY LIMITED, Dunstable (GB)

(72) Inventors: Benjamin Stokes, Ringwood (GB); James A. Luckemeyer, San Antonio, TX (US); Christopher Locke, Bournemouth (GB); Benjamin A. Pratt, Poole (GB)

(73) Assignee: HUNTLEIGH TECHNOLOGY LIMITED, Dunstable (GB)

(21) Appl. No.: 14/422,438

(22) PCT Filed: Aug. 21, 2013
(86) PCT No.: PCT/US13/55975

§ 371 Date: Feb. 19, 2015

Related U.S. Application Data
(60) Provisional application No. 61/691,605, filed on Aug. 21, 2012.

(51) Int. Cl. A61G 7/10; A61G 7/057

(52) U.S. Cl. CPC A61G 7/1021; A61G 7/1051; A61G 7/05776; A61G 2205/20

(57) ABSTRACT

A device and method for transporting or repositioning a patient. The device comprises an air mover; a multi-layered body comprising a layer that is permeable to fluids, an layer comprising a spacer material, with which the air mover is in fluid communication, and a layer having a tensile strength sufficient to support the weight of a patient being lifted by the patient transport device. The device further comprises a plurality of coupling members coupled to the multi-layered body. In certain embodiments, the device comprises a further layer comprising a fluid-absorbent material.

### CROSS-REFERENCE TO RELATED APPLICATIONS

This application claims priority to U.S. Provisional Patent Application Ser. No. 61/691,605, filed Aug. 21, 2012 incorporated by reference herein.

### FIELD OF THE INVENTION

The present disclosure relates generally to apparatus, methods, and systems used to transport or reposition patients or other persons who need assistance in being repositioned.

### BACKGROUND

For various reasons, it is sometimes desirable to move patients within a care facility. This often requires a range of support depending upon the mobility and capability of the patient, which can be further complicated by size, weight and health conditions. Patients and other persons restricted to bed for extended periods often require assistance in being repositioned within a bed or transferred from one bed to another bed or support surface. Depending on the type of transport or repositioning being performed, a caregiver may need to employ a lifting sling, a transfer sheet, a roll sheet, or a repositioning sheet. A lifting sling may be used when a person is being lifted out of bed with an overhead lifting device, while a transfer sheet may be used to transfer a person from one bed to another support surface. A roll sheet may be used to roll a person within a bed, and a repositioning sheet may be used to transversely move a patient towards one end or one side of a bed.

In typical prior art systems, the transport or repositioning device is not left underneath the patient when not in use. The device may not be left under the patient for a number of reasons. For example, the material from which the device is constructed may have a high coefficient of friction so that it is not comfortable for the patient and may cause skin breakdown after extended exposure. The transport device may also have undesirable air, vapor, or liquid permeability which can lead to skin breakdown. Therefore, the repositioning device is typically removed after use so that it does not remain between the patient and the support surface.

Because transport devices are not typically left in place when not in use, it is necessary for a caregiver to locate a suitable device before performing a transport or repositioning maneuver. This may take considerable time on the part of the caregiver because a limited number of such devices are typically kept at a care facility. In addition, depending on the type of maneuver being performed, a caregiver may have to locate a specific type of device (e.g., a lifting sling, a transfer sheet, a roll sheet, or a repositioning sheet). It is therefore desirable to reduce the amount of time that a caregiver must spend locating a proper repositioning device.

Furthermore, once the caregiver has located the proper device, the person being repositioned must be turned, lifted, or otherwise manipulated by the caregiver (or caregivers) so that the repositioning device can be placed underneath the person. Such manipulation of the patient can present ergonomic challenges that may strain the caregiver and increase the risk of injury to the caregiver. Recent initiatives, such as the Handle with Care campaign launched by the American Nurses Association, have led to legislation that limits the amount of a patient's weight that a caregiver may lift.

Existing transfer/transport devices do not body manage body fluids at the skin interface that often result from sweat and/or incontinence, which can cause skin maceration and skin breakdown. Absorptive pads as typically placed below such patients, whether in bed or in a wheelchair or other transport device, which must be changed periodically.

After the patient has been moved, often there is a need to remove the transport device. For bariatric patients in particular, this may be very difficult for both the caregiver and patient. This can be made worse if one considers that the transport device must be removed once they have been placed back on the bed, and the patient may then have to be re-positioned with a different device. For example, during a typical bed-to-chair-to-bed transfer, a patient may have to be maneuvered and re-positioned four times to manage transfer and re-positioning devices. During the positioning of the device, the fragile skin of the patient can also be susceptible to friction burns as the transport/positioning device material is pulled from beneath them.

Such difficulties in repositioning patients can create delays in patient repositioning. These delays can be problematic when excessive fluid has developed at the interface between the patient and the support surface, which can lead to skin breakdown.

### SUMMARY

Certain exemplary embodiments of the present disclosure comprise a system and method for transporting or repositioning a person.

Any embodiment of any of the present devices, apparatus, and systems can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

### BRIEF DESCRIPTION OF THE DRAWINGS

While exemplary embodiments of the present invention have been shown and described in detail below, it will be clear to the person skilled in the art that changes and modifications may be made without departing from the scope of the invention. As such, that which is set forth in the following description and accompanying drawings is offered by way of illustration only and not as a limitation. The actual scope of the invention is intended to be defined by the following claims, along with the full range of equivalents to which such claims are entitled.

In addition, one of ordinary skill in the art will appreciate upon reading and understanding this disclosure that other variations for the invention described herein can be included within the scope of the present invention. For example, different materials of construction may be used for the layers employed in the system. Furthermore, the number of layers and the number and location of the handles may also be altered.

In the following Detailed Description of Disclosed Embodiments, various features are grouped together in several embodiments for the purpose of streamlining the disclosure. This method of disclosure is not to be interpreted as reflecting an intention that exemplary embodiments of the invention require more features than are expressly recited in each claim. Rather, as the following claims reflect, inventive subject matter lies in less than all features of a single disclosed embodiment. Thus, the following claims are hereby incorporated into the Detailed Description of Exemplary Embodiments, with each claim standing on its own as a separate embodiment.

FIG. 1 illustrates a perspective view of a first exemplary embodiment of a patient transport device;

FIG. 2 illustrates a section view of the embodiment of FIG. 1;

FIG. 3 illustrates a perspective view of a second exemplary embodiment of a patient transport device;

### DETAILED DESCRIPTION OF DISCLOSED EMBODIMENTS

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art.

The terms “comprise” (and any form of comprise, such as “comprises” and “comprising”), “have” (and any thrill of have, such as “has” and “having”), “include” (and any form of include, such as “includes” and “including”) and “contain” (and any form of contain, such as “contains” and “containing”) are open-ended linking verbs. As a result, a device or kit that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

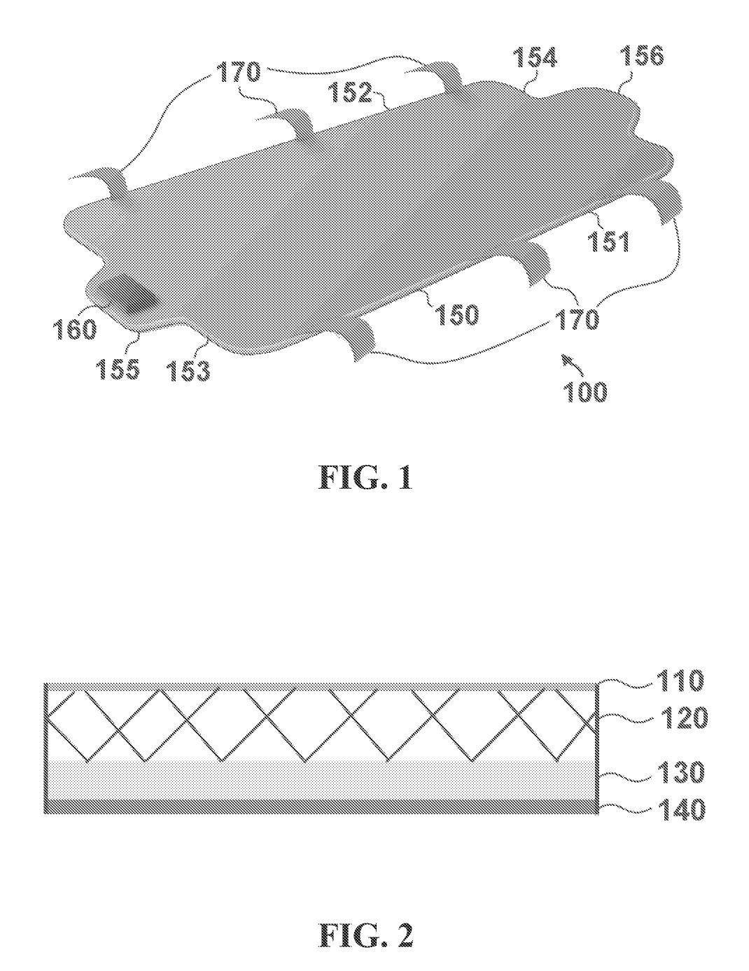

Further, a device, apparatus or system that is configured in a certain way is configured in at least that way, but it can also be configured in other ways than those specifically described. Referring now to FIGS. 1-2, a patient transport device 100 comprises a multi-layered body 150, an air mover 160 and a plurality of coupling members 170. In the embodiment shown, multi-layered body 150 is substantially planar and comprises a first side 151, a second side 152, a first end 153 and a second end 154. In this embodiment, patient transport device is generally rectangular in shape when viewed from above and comprises a length (extending between first end 153 and second end 154) that is greater than its width (extending between first side 151 and second side 152). This embodiment also comprises a first extension 155 extending from first end 153 and a second extension extending from second end 154.

Multi-layered body 150 comprises a plurality of layers as illustrated in the section view of FIG. 2. In this particular embodiment, multi-layered body 150 comprises a first layer 110 that will be in contact with a patient during use. In this embodiment, first layer 110 is permeable to fluids and air. In the embodiment shown, support portion 150 also comprises a second layer 120 which is configured as a hydrophilic manifold or spacer material that separates first layer 110 and a third layer 130. As used in this disclosure, the term “spacer material” (and related terms) should be construed broadly to include any material that includes a volume of air within the material and allows air to move through the material.

In exemplary embodiments, spacer materials allow air to flow through the material when a person is positioned on the material while the material is supported by a mattress or other support surface, including for example a chair or examination table. Examples of such spacer materials include open cell foam, polymer particles, and a material sold by Tytex under the trade name AirX™. In particular embodiments, second layer 120 may be configured as an open cell foam that is configured to allow air flow through the material when patient transport device 100 is supporting the weight of a person during use.

In this embodiment, multi-layered body 150 also comprises an optional third layer 130 that is absorbent and capable of absorbing fluids from a patient supported by patient transport device 100. It is understood that other embodiments may not include third layer 130 in order to reduce manufacturing costs and complexity. The embodiment shown also comprises a fourth layer 140 that is configured to support the weight of a patient being transported by patient transport device 100 during use. In certain embodiments, fourth layer 140 is hydrophobic and is not permeable to fluid or air. In specific embodiments, fourth layer 140 (and coupling members 170, discussed below) are configured to support the weight of a patient weighing 400, 500, or 600 pounds during use. In other embodiments, fourth layer 140 and coupling members 170 may be configured to support the weight of patient weighing less than 400 pounds.

In certain exemplary embodiments, air mover 160 may be located proximal to first extension 155 and may comprise a guard or other partition (not shown) to prevent material from the layers of multi-layered body 150 or the surrounding environment from blocking the inlet or outlet of air mover 160. In particular embodiments, air mover 160 may be battery-powered, while in other embodiments air mover 160 may be powered via an electrical connection to a typical power source such as an alternating current outlet or any suitable power supply.

In this embodiment, patient transport device 100 further comprises a plurality of coupling members 170 spaced along first side 151 and second side 152. Coupling members 170 can be used to couple patient transport device 100 to a lifting mechanism (e.g., a hoist or other suitable equipment) configured to lift a patient and patient transport device 100 from a bed or chair for transport purposes. in particular embodiments, coupling members 170 may be straps that can be secured to a lifting mechanism via suitable components, including for example, clasps, pins, snaps, hook-and-loop fasteners, etc. In specific embodiments, coupling members 170 may be configured to also couple to the bed or chair when the patient is not being transported.

During use, patient transport device 100 can be placed under a patient who will eventually need to be transported from one support surface to another (e.g., from a hospital bed to a chair) so that the patient is in contact with first layer 110. The features of patient transport device 100 can allow the device to remain under the patient for extended periods of time without skin damage or discomfort while also addressing the moisture management needs of the interface between the patient and patient transport device 100.

For example, moisture vapor that develops between the patient and first layer 110 can pass through first layer 110 and into air pockets of second layer 120. Moisture vapor will continue to transfer to air pockets within second layer 120 while the air pockets are at a lower relative humidity than the air adjacent at the interface between first layer 110 and the patient. As the relative humidity of the air pockets in second layer 120 increases and approaches the relative humidity of the air adjacent to the patient, the transfer rate of moisture vapor will decrease. It is therefore desirable to maintain a lower relative humidity of the air pockets within second layer 120 than the relative humidity of the air adjacent to the patient. As the moisture vapor is transferred to air pockets within second layer 120, it is therefore desirable to remove moisture vapor from the air pockets and lower the relative humidity of the air within second layer 120. By removing moisture vapor from the air within second layer 120, the transfer rate of moisture vapor from the patient can be maintained at a more uniform level.

Air mover 160 can be operated to provide air movement through second layer 120 to reduce pressure within second layer 120 to remove moisture vapor. This lowers the relative humidity of the air pockets and allows the transfer rate of moisture vapor to be maintained over time. This can allow a patient to remain in contact with patient transport device 100 for an extended period of time while reducing the risk of skin complications due to excessive moisture at the patient interface, including for example, decubitus ulcers.

In the event that excessive fluid is present during use (e.g. urine or excessive sweat from the patient), third layer 130 is configured to absorb the fluid and reduce the likelihood of fluid leakage from patient transport device 100. Third layer 130 can absorb the fluid and allow air movement created by air mover 160 to evaporate the fluid over an extended period of time. The ability of third layer 130 to absorb excess fluid can also reduce the size and power requirements of air mover 160 in order to effectively address situations of excessive fluid loading.

In certain embodiments, patient transport device 100 may also comprise an indicator for indicating when patient transport device 100 is no longer effectively removing fluids. In particular embodiments, patient transport device 100 may comprise a color change dye that indicates when the fluid is no longer evaporating and patient transport device 100 should be replaced. Particular embodiments may comprise wicking layers included such that fluid would be drawn to the indicator if patient transport device 100 (e.g., third layer 130 in particular) becomes saturated to the extent that evaporation will no longer be effective at removing fluids.

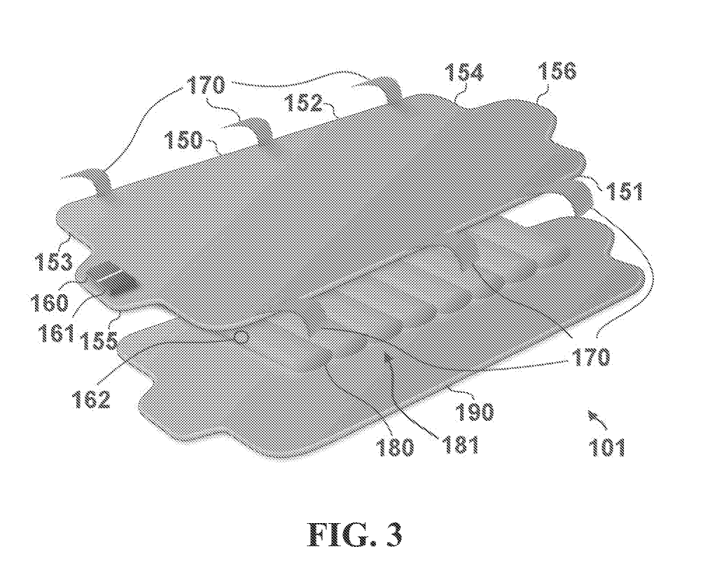

Referring now to FIG. 3, a second embodiment of a patient transport device 101 is generally equivalent to the previously-described embodiment in FIGS. 1-2, however patient transport device 101 also comprises an inflatable member 180 and a base layer 190. In this embodiment, inflatable member 180 is located between multi-layered body 150 and base layer 190. In certain embodiments, the pressure within inflatable member 180 can be varied to provide local alternating pressure or other off-loading support to a patient in contact with patient transport device 101. In particular embodiments, inflatable member 180 and base layer 190 may be reusable and multi-layered body 150 may be disposable. In such embodiments, for example, fourth layer 140 (FIG. 2) may fluid impermeable and can prevent fluid from contacting inflatable member 180 and base layer 190.

In particular embodiments, inflatable member 180 may be inflated via a low power air pump 161 that is coupled to inflatable member 180 via conduit (not shown). In certain embodiments, inflatable member 180 may comprise a plurality of inflatable compartments 181 in which the pressure may be individually controlled, In specific embodiments, air pump 161 may be mounted within a housing or foam block structure within patient transport device 101, including for example proximal to first end 153 in first extension 155. In certain embodiments, air pump 161 may be configured as diaphragm pump. In a specific embodiment, air pump 161 may be similar to a device sold under the brand name Koge and model number KV8.

Exemplary embodiments of patient transport device 101 may also comprise a pressure control system, including a pressure sensor 162 in communication with air pump 161. In particular embodiments, the pressure control system may be configured to control the pressure in inflatable member 180. In specific embodiments, the pressure control system may be configured to control the pressure in individual inflatable compartments 181 in order to provide alternating pressure therapy to a patient supported by patient transport device 101.

The cell inflation system would require at the lowest level of complexity a pump, controller, battery, relief valve and a pressure sensor. This would provide for a system which had a series of cells which all inflated together to a single set pressure. For further control of alternating cells, a plurality of pressure sensing means and valves are required in order that the cell pressures may be changed individually or in groups. One would suggest that having two groups of 3 to 4 cells would be sufficient. Constructing a system to do this is well described in the art and one skilled will be able to assemble such a system. It is new to think of combining this with a forced air-flow sling as described.

1. A patient transport device comprising:
an air mover;
a multi-layered body having a first side, a second side, a first end and a second end, wherein the multi-layered body comprises:
a first layer that is permeable to fluids;
a second layer comprising a spacer material, wherein the air mover is in fluid communication with the second layer; and
a third layer having a tensile strength sufficient support the weight of a patient being lifted by the patient transport device; and
a plurality of coupling members coupled to the multi-layered body.

2. The patient transport device of claim 1 further comprising a fourth layer comprising a fluid-absorbent material.

3. The patient transport device of claim 2 wherein the fourth layer is disposed between the second layer and the third layer.

4. The patient transport device of claim 1 further comprising an indicator configured to indicate when the third layer is saturated with fluid.

5. The patient transport device of claim 4 wherein the indicator is a dye configured to change color when the third layer is saturated with fluid.

6. The patient transport device of claim 5 wherein the dye is located proximal to either the first or second side or the first or second end of the multi-layered body.

7. The patient transport device of claim 1 wherein the fourth layer is impermeable to fluid and air.

8. The patient transport device of claim 1 Wherein second layer is an open celled foam.

9. The patient transport device of claim 1 wherein the multi-layered body comprises an inflatable member.

10. The patient transport device of claim 1 wherein air mover is a centrifugal fan.

11. The patient transport device of claim 1 wherein the air mover is battery powered.

12. The patient transport device of claim 1 wherein the fourth layer has a tensile strength sufficient support the weight of a patient weighing 400 pounds being lifted by the patient transport device.

13. The patient transport device of claim 1 wherein the fourth layer has a tensile strength sufficient support the weight of a patient weighing 500 pounds being lifted by the patient transport device.

14. The patient transport device of claim 1 wherein the fourth layer has a tensile strength sufficient support the weight of a patient weighing 600 pounds being lifted by the patient transport device.

15. A method of transporting a patient, the method comprising:
providing a patient transport device according to claim 1;
placing the patient in a first position on the transport device so that the patient is in contact with the first layer of the transport device;
manipulating the transport device so that the patient is repositioned to a second position.

16. The method of claim 15 wherein the patient transport device comprises a fourth layer comprising a fluid-absorbent material and wherein a fluid from the patient travels through the first and second layers and is absorbed in the fourth layer of the transport device while the patient is in contact with the first layer of the transport device.

17. The method of claim 16 wherein the transport device comprises an indicator that indicates if the fourth layer becomes saturated with the fluid.

18. The method of claim 16 wherein the air mover directs an air flow through the second layer to evaporate fluid from the second layer.

19. The method of claim 15 wherein the patient is in contact with the first layer of the transport device for a period of time greater than 24 hours.

20. The method of claim 15 wherein manipulating the transport device so that the patient is repositioned to a second position comprises coupling a lifting mechanism to one or more of the coupling members and lifting the transport device.

21. The method of claim 15 wherein the transport device comprises an inflatable member, and wherein a pressure in the inflatable member is varied while the patient is in contact with the first layer of the transport device.

22. The method of claim 21 wherein the inflatable member comprises a plurality of inflatable compartments.
